(19) United States
(12) Patent Application Publication
(10) Pub. No.: US 2026/0338011 A1
(43) Pub. Date: Oct. 29, 2026

(54) MOTOR VEHICLE DOOR LATCH

(71) Applicant: Kiekert Aktiengesellschaft, Heiligenhaus (DE)

(72) Inventors: Robert J. Hunt, Davisburg, MI (US); Scott Brown, Livonia, MI (US)

(73) Assignee: Kiekert Aktiengesellschaft, Heiligenhaus (DE)

(21) Appl. No.: 19/192,447

(22) Filed: Apr. 29, 2025

(51) Int. Cl. E05B 83/36; E05B 79/04; E05B 85/02

(52) U.S. Cl. CPC E05B 83/36; E05B 79/04; E05B 85/02

(57) ABSTRACT

A motor vehicle door latch includes a door lock with a locking mechanism and a lock holder pivotably arranged on the motor vehicle, wherein in particular the lock holder is adjustable with respect to the door lock, and wherein the lock holder is arranged in the motor vehicle so as to be pivotable into an engagement region of the door lock.

The invention relates to a motor vehicle door latch having a door lock with a locking mechanism and a lock holder pivotably arranged on the motor vehicle, wherein in particular, the lock holder is pivotable with respect to the door lock.

Motor vehicle door latches are used where pivoting, sliding, or folding components arranged on the motor vehicle must be held securely in their position. Now, in particular for transport vehicles, roller doors or accesses that can be closed with louvers are also being used. One area of application could, for example, be parcel services. These motor vehicles use roller doors that close, for example, a loading flap. These roller doors must also be secured by vehicle door latches when the vehicle is used in driving mode.

If door locks are used on vehicles with roller doors, they also use door locks that are equipped with a locking mechanism and that work together with a lock holder. To enable interaction, either the door lock must be moved into the region of movement of the lock holder, or the lock holder must enter into the door lock—for example, when shifting or moving the roller door. In any case, an overlapping of door lock components must occur to enable the locking mechanism to engage. In any case, however, access to the vehicle should be free, to protect neither luggage nor the operator from injury.

One option for shifting or pivoting a lock holder has become known from DE 10 2005 062 998 A1 . The document discloses a pivotable lock holder, which can also be referred to as a servo lock holder, in which, after a first locking of the lock holder in the door lock, the lock holder is able to transfer the door element movably arranged on the motor vehicle into a main locking position. A main locking position is a position of the door element in which the door element is in the completely closed position. In other words, the locking mechanism is first engaged, and then the lock holder shifts the door element into the closed position. Such pivoting lock holders are used, for example, in tailgates of motor vehicles.

With regard to a roller door, such a closing function with a servo lock holder could also be used. To close the roller doors, and in particular for parcel services, a quick opening and closing of the roller door is preferred. In addition, it is essential for delivery services that access to the motor vehicle can be as unobstructed as possible. A protruding lock holder or a door lock protruding into the opening region of the cargo area can hinder the loading or unloading of the motor vehicle and can also lead to injuries to the motor vehicle driver. The problem therefore consists in enabling unobstructed access to the motor vehicle and at the same time allowing quick opening. This is where the invention comes in.

The object of the invention is to provide an improved motor vehicle lock. Furthermore, it is an object of the invention to provide a door lock which enables obstacle-free access to the motor vehicle and which is also structurally simple and cost-effective.

The object is achieved by the features of independent claim 1. Advantageous embodiments of the invention are specified in the dependent claims. It should be noted that the embodiments described below are not limiting; rather, any possible variations of the features described in the description and the dependent claims are possible.

According to claim 1, the object of the invention is achieved by providing a motor vehicle door latch having a door lock with a locking mechanism and a lock holder pivotably arranged on the motor vehicle, wherein in particular, the lock holder is pivotable with respect to the door lock, and the lock holder is arranged in the motor vehicle so as to be pivotable into an engagement region of the door lock. By a pivotable connection of the lock holder on the motor vehicle and the option of moving the lock holder into the engagement region of the door lock, access to the motor vehicle can be kept free. When the motor vehicle is in an open state, i.e., a door element is in an open position, the lock holder is positioned on the motor vehicle in such a way that an access region to the vehicle can be entered unhindered. In other words, the lock holder pivots out of the engagement region of the door lock in such a way that access to the transport or storage space in the motor vehicle is unhindered.

The motor vehicle door latch consists of the door lock and the lock holder. The door lock and lock holder together form the motor vehicle door latch and enable a component movably attached to the motor vehicle to be positioned securely and in a storage-friendly manner during operation of the motor vehicle. It is also conceivable, e.g., in the case of the use of the motor vehicle door latch on a loading ramp or a large one, that a motor vehicle door latch also be arranged on both sides of the roller door. However, it is also conceivable that the motor vehicle door latch be located centrally on the roller door, for example. The door lock comprises a locking mechanism consisting of a rotary latch and pawl so that, in conjunction with the lock holder, locking of the locking mechanism is feasible. For this purpose, the rotary latch is pivoted in a relative movement between the door lock and the lock holder, and the spring-loaded pawl engages in at least one locking surface of the rotary latch, whereby the locking mechanism is engaged. The latched locking mechanism holds the lock holder in a pre-latching and/or main latching position.

The lock holder can be held in the motor vehicle by means of a spring preload. By means of a spring preload, the lock holder can be held in such a way that, in a released state, i.e., a state released from the door lock, the lock holder can be positioned out of the engagement region with the door lock. In other words, a spring element can be arranged on the lock holder or a receptacle of the lock holder, which adjusts the lock holder after unlocking the locking mechanism and releasing it from the engagement region with the door lock into a position in which the lock holder releases access to the motor vehicle. Alternatively, the lock holder can also be arranged on a roller door, for example, in such a way that the lock holder is pivoted out of the engagement region with the door lock, and free sliding of the roller door is possible. In any case, neither the lock holder nor the motor vehicle lock prevents access to the motor vehicle. It is therefore possible to enter and operate the motor vehicle safely and without danger. In particular, for example, with respect to a delivery vehicle, the goods to be delivered cannot come into contact with obstructive motor vehicle door latch components.

In a further development of the invention, the lock holder can be positioned out of an engagement region of the door lock by means of a spring, in particular a leg spring. Holding the lock holder can therefore be done using simple structural means. For this purpose, the lock holder is preferably attached to a cross-member, wherein the cross-member can be positioned by means of the spring, in particular the leg spring. For this purpose, the leg spring can be arranged on a pivot axis of the cross-member and interact with the cross-member and the body or a body component. The lock holder can therefore be positioned using the simplest structural means, and economically.

It has proven particularly advantageous if the lock holder is attached to a pivotably mounted cross-member. The lock holder can be moved out of the engagement region with the motor vehicle lock and positioned by means of a spring element. For this purpose, the lock holder can be arranged on a cross-member extending in the longitudinal direction from a pivot axis and preferably on a free end, opposite the pivot axis, of the cross-member. This makes it possible to move the lock holder and pivot it in such a way that engagement in the motor vehicle lock is enabled. Only in the unlatched state, i.e., out of engagement with the motor vehicle lock, is the lock holder then pivoted around a pivot axis of the cross-member and located outside the access to the motor vehicle. Preferably, the cross-member is arranged on the roller door or louver door or sliding door element so that an operator can enter the motor vehicle unhindered. Preferably, the cross-member is arranged on the movable component of the motor vehicle in such a way that the lock holder or the cross-member is always covered by the door element. In other words, the cross-member does not protrude beyond one end of the door element and is overlapped with the door element. The cross-member is preferably made of a steel material and a sheet metal, and can additionally have at least one reinforcing bead.

If the cross-member can be positioned by means of a guide element, in particular a guide bolt, this results in a further advantageous design variant of the invention. In order to enable safe guidance of the cross-member and, in particular, to enable a defined swinging in the direction of the motor vehicle lock, a guide bolt can be attached to the cross-member or the pivoting holder of the lock holder. The guide element can, for example, be present as a metal bolt riveted to the cross-member. It is, however, also conceivable that the bolt be welded, i.e., integrally bonded, or screwed to the cross-member. In principle, the bolt can be a metallic base body, but to reduce noise, the bolt can also have a plastic coating, for example.

It has proven particularly advantageous if the guide element can be brought into engagement with a guide plate. Ultimately, the lock holder attached to the cross-member interacts with the locking mechanism in the motor vehicle lock. In order to then ensure a defined introduction into the motor vehicle lock and to achieve the greatest possible freedom during the installation of the motor vehicle lock in the motor vehicle, a guide plate can be used. The guide plate is designed in such a way that at least one insertion surface is provided which can be brought into direct engagement with the guide element on the cross-member. Consequently, if the lock holder is moved with the roller door when the cargo area is open, the guide element first engages with the insertion surface on the guide plate and therefore enables a defined guidance of the cross-member and therefore the lock holder in relation to the motor vehicle lock. In addition to the insertion region, the guide plate can also have a slot-shaped guide contour in order to guide the lock holder to the motor vehicle lock in a defined manner. Preferably, but not restrictively, the guide slot is located at least partially in the region of a central axis of an insertion region of the motor vehicle lock.

In an advantageous development of the invention, the guide plate is designed to be adaptable to a body. In other words, the guide plate fits snugly against a contour of the body. The guide plate is preferably aligned with the body of the motor vehicle and in the direction of the opening or access of the motor vehicle. The guide plate is preferably made of a metallic sheet, such that the guide plate can be adapted to the body by, for example, a bend, such that the guide plate fits snugly against the body without forming a sharp edge towards the access of the motor vehicle. A form-fitting connection to the body therefore prevents injuries and can also satisfy aesthetic considerations.

If the cross-member has a stop, a design variant of the invention can again be achieved. The cross-member is accommodated in the motor vehicle pivotably and spring-preloaded. The cross-member is held by a pivot axis and preloaded against the body or roller door by means of, for example, a leg spring. If an extension and/or recess is provided on the cross-member itself, for example, which can be brought into engagement with the roller door, a defined positioning of the cross-member can be achieved. The direct formation of a stop on the cross-member itself reduces to a minimum the required components for guiding the lock holder.

It has proven particularly advantageous if the cross-member can be pivotably accommodated in a receiving bearing. A receiving bearing for the cross-member forms a bearing to provide a counter-stop for the cross-member, and, at the same time, the cross-member can be held pivotably in the receiving bearing. The receiving bearing can preferably be made from a steel material and as a stamped and bent part. The receiving bearing makes it possible to mount the cross-member securely and in the correct position to, for example, a roller door, and at the same time hold the cross-member in the correct position during the movement of the roller door and guide it in relation to an interaction with the motor vehicle lock and/or the guide plate. A bearing point for the swivel movement is provided on one side of the cross-member, and, at the same time, the stop means can be arranged at the bearing point. The lock holder and a guide bolt can be arranged at an end, opposite the bearing point, of the cross-member. Accordingly, a high level of functionality can be provided with the cross-member. The cross-member can be held securely and in the correct position when the roller door is moving and, on the other hand, a secure interaction between the cross-member, the guide plate, and the motor vehicle lock can be ensured. In any case, the access region for the motor vehicle is kept clear when the roller door or loading flap is open. The form-fitting connection of the guide plate can, moreover, prevent a risk of injury to the operator.

Additional safety and increased stability can be achieved by arranging a reinforcement plate on the receiving bearing. In order to be able meet the safety requirements and provide sufficient stability in the receiving bearing, a reinforcement plate can be arranged on the receiving bearing, depending upon the design of the motor vehicle locking system. An additional reinforcement plate offers the advantage that the stability can be adapted to the requirements. However, a single arrangement of a receiving bearing can also be sufficient. The reinforcement plate can extend over the mounting surface of the receiving bearing and additionally support the bearing point of the cross-member or the pivot axis of the cross-member.

In a further development of the invention, it can be advantageous if the guide element can be designed as part of the lock holder. The guide element extends from the cross-member in such a way that the guide element can engage in the guide plate. Advantageously, the lock holder and guide element are arranged on opposite sides of the cross-member. If the guide element is designed as an extension of the lock holder, wherein at least part of the lock holder extends through the cross-member, the number of required components for guiding the cross-member can be reduced to a minimum. The lock holder is preferably designed as a lock holder bracket, wherein only one leg of the lock holder bracket can have an extension through the cross-member. However, it is also conceivable that the lock holder be designed as a lock holder bolt and the lock holder bolt extend through the cross-member so that there is a bolt arranged on both sides of the cross-member.

In a further development of the invention, an advantage arises if the door lock is arranged in the motor vehicle in a direction deviating from a direction of movement of the door element. The motor vehicle door or door element is preferably a roller door, an awning, or a similarly designed door element, which is preferably held in guide rails in the motor vehicle. During an opening process, the roller door, for example, is guided linearly and performs a movement in the y-direction, relative to the motor vehicle. An xyz coordinate system in a motor vehicle is usually positioned such that an x-direction runs in the longitudinal direction of the motor vehicle, a y-direction is arranged in the transverse direction, and a z-direction is arranged in the vertical direction. The roller door moves linearly in the z-direction, at least in the closing region, i.e., in the region where there is interaction with the lock. An arrangement of the door lock can deviate from the z-direction with respect to the insertion region of the motor vehicle lock. This has the advantage that the motor vehicle lock can also be arranged in a region next to the access to the motor vehicle. Starting from the z-direction, i.e., the vertical direction with respect to the motor vehicle, the orientation of an insertion region for the lock holder into the motor vehicle lock can deviate from the z-direction.

It has proven advantageous if the deviating direction of the insertion region of the motor vehicle lock forms an angle of greater than 20°, preferably greater than 30°, and even more preferably of ca. 40°, for the lock holder. By arranging the motor vehicle lock in a different direction, the previously described arrangement of the motor vehicle lock next to the access can be realized. The lock holder can be guided in combination with the cross-member and the guide plate in such a way that the lock holder is guided in a straight line, i.e., along a center line of the insertion region of the motor vehicle lock, and is inserted into the motor vehicle lock. This allows for a high level of functionality of the motor vehicle lock and, in particular, the interaction between the lock holder and the motor vehicle lock to be achieved, since an optimal alignment between the lock holder and the motor vehicle lock can be achieved. This can ensure high functionality on the one hand, and keep the access region of the motor vehicle free of parts of the motor vehicle door latch on the other.

It can furthermore be advantageous if the door lock is able to be arranged directly on the guide plate. By arranging the motor vehicle lock directly on the guide plate, a very precise alignment of the motor vehicle lock can be achieved, and the number of required components can be reduced. In addition, a modular design of the motor vehicle door latch can be realized if the components of the motor vehicle door latch can be provided as a module prefabricated for installation on the motor vehicle. The motor vehicle door lock can be provided prepared on the guide plate, and the cross-member can be mounted on the motor vehicle premounted on the receiving bearing or on the reinforcement plate. In any case, the design according to the invention of the motor vehicle door latch provides the option of enabling safe entry into the access region and, at the same time, of making the access region free of the motor vehicle door latch.

The invention is explained in more detail below with reference to the accompanying drawings on the basis of a preferred exemplary embodiment. However, the principle applies that the exemplary embodiment does not limit the invention, but is merely an advantageous design.

In the figures:

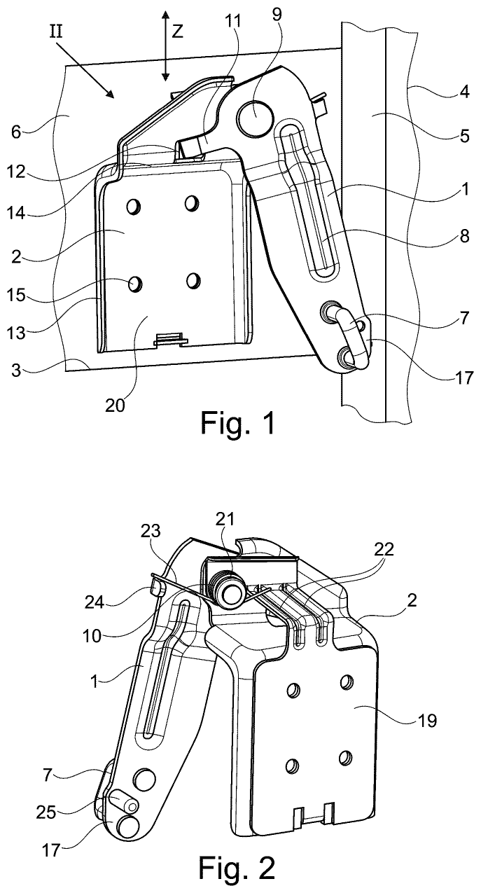

FIG. 1 is a three-dimensional view of a receiving bearing with a lock holder, pivotally attached thereto, on a cross-member,

FIG. 2 is a view of the bearing of the cross-member according to arrow II from FIG. 1,

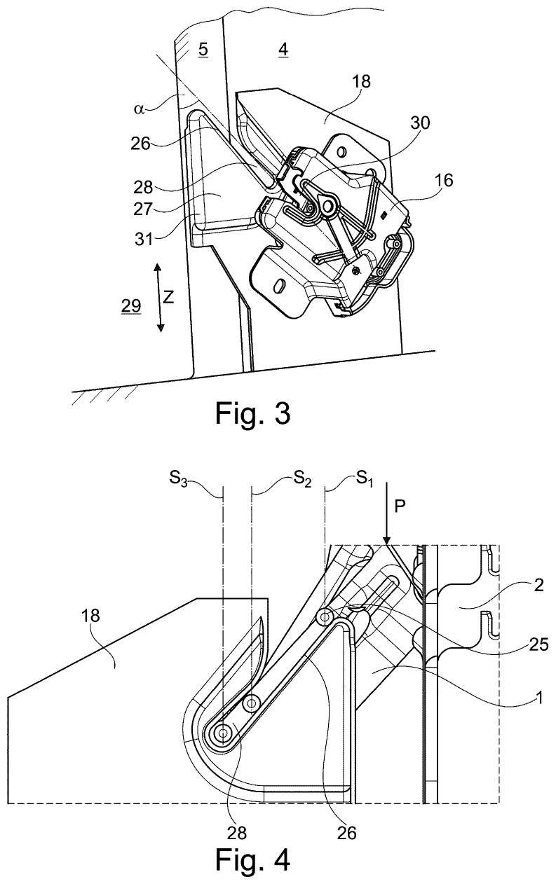

FIG. 3 is a three-dimensional view of a motor vehicle lock which is attached to a guide plate in the motor vehicle,

FIG. 4 is a rear view of the guide plate, the cross-member, and the receiving bearing, with the cross-member interacting with the guide plate in different functional positions, and

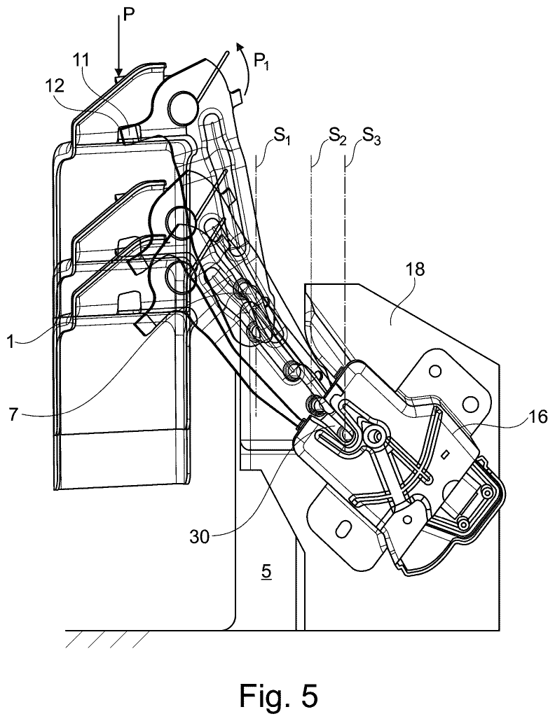

FIG. 5 is a top view of the cross-member, with the lock holder interacting with the motor vehicle in a closing movement.

FIG. 1 shows a top view of a cross-member 1 and a receiving bearing 2. The receiving bearing 2 is, for example, shown on a roller door 3 of a motor vehicle 4. The roller door 3 is guided via a guide rail 5 in the motor vehicle and is able to be moved linearly up and down in the direction of arrow Z. The receiving bearing 2 is attached to a separate segment 6 of the roller door 3. In this respect, if access to the motor vehicle 4 were open, the guide rail 5 would limit the opening of the motor vehicle.

A lock holder in the form of a lock holder bracket 7 is attached to the cross-member 1. The cross-member 1 further has a reinforcing bead 8 and is pivotably arranged in the receiving bearing 2 via a pivot axis 9. By means of a leg spring 10 depicted in FIG. 2, the cross-member 1 is spring-preloaded in the receiving bearing 2. An extension 11 on the cross-member 1 serves as a stop 11. The stop 11 interacts with a recess 12 in the receiving bearing 2. In addition to the recess 12, bevels 13, 14 are arranged on the receiving bearing 2, which serve on the one hand to position the cross-member 1, as well as to stabilize the bearing point or the pivot axis 9 of the cross-member 1. The receiving bearing 2 can be attached to the segment 6 of the roller door 3 via bores 15.

The position of the cross-member 1 depicted in FIG. 1 therefore shows an least partially open roller door, since the cross-member 1 and hence the lock holder 7 are portrayed as detached from a motor vehicle lock 16. The receiving bearing 2 as well as the cross-member 1 are moved with the roller door 3 and therefore provide access to the motor vehicle. The cross-member 1 projects at least partially beyond the guide rail 5 attached to the motor vehicle 4. In particular, an end region 17 of the cross-member 1 projects beyond the guide rail 5 and is therefore able to enter into engagement with a guide plate 18.

FIG. 2 portrays a rear view of the receiving bearing 2 according to the arrow II from FIG. 1. The receiving bearing as well as the cross-member 1 are depicted as detached from the motor vehicle. It can be seen that a reinforcement plate 19 is additionally arranged on the receiving bearing 2. The reinforcement plate 19 extends over the entire mounting region of the receiving bearing 2 and consequently stabilizes the receiving bearing as well as a bearing point 21 of the cross-member 1. This can be clearly seen in FIG. 2, wherein it can also be seen that additional beads 22 stabilize the reinforcement plate 19. The leg spring 10 is supported on one side on the reinforcement plate 19 and lies with another leg 23 on a bevel 24 on the cross-member. Accordingly, the cross-member is preloadably held spring-supported against the receiving bearing 2.

A guide element in the form of a guide bolt 25 is mounted on a side of the cross-member 1 opposite the lock holder 7. The guide bolt 25 and lock holder 7 can, for example, be permanently connected to the cross-member 1 by means of forming—for example, cold riveting. The lock holder 7 and guide bolt 25 are arranged at an end region 17 of the cross-member. At least the guide bolt projects into the region of the guide rail 5 on the motor vehicle 4, such that the guide bolt can be brought into engagement with the guide plate 19.

The guide plate 18 with the motor vehicle lock 16 attached thereto is portrayed in FIG. 3. It can be seen that the guide plate 18 is at least attached to the body 4 of the motor vehicle 4. The guide plate 18 extends over the guide rail 5 so that the guide plate 18 and in particular a guide surface 26 can come into engagement with the guide bolt 25. The extension 27 of the guide plate 28 consequently covers the guide rail 5, so that the cross-member 1 can interact with the guide plate 18. In addition to the guide surface 26, the guide plate 18 has a guide slot 28 which is offset by an angle a to a vertical extension of the access region 29. The access region 29 to the motor vehicle is closed by means of a roller door 3, wherein the open position of the roller door is portrayed in FIG. 3.

The motor vehicle lock 16 is attached to the guide plate 18 and is also arranged offset by the angle a in the body 4 of the motor vehicle. An insertion region 30 of the motor vehicle lock 16 is therefore arranged in the motor vehicle 4 offset by the angle a, with respect to the access and in particular the direction Z. As usual, in the motor vehicle lock 16, there is a locking mechanism which interacts with the lock holder 7 in a known manner. The motor vehicle lock 16 can be a single-or double-latch lock and can also be a mechanically or electrically actuated motor vehicle lock 16. In other words, the motor vehicle lock 16 can be unlocked, i.e., actuated, manually and/or electrically.

FIG. 4 shows the interaction of the cross-member 1 with the guide plate 18. Different closing positions of the motor vehicle door latch are depicted; starting from an open roller door, the closing process is portrayed here. The cross-member 1 and therefore the receiving bearing 2 and the roller door 3 are moved in the direction of the arrow P in the Z-direction, such that the guide bolt 25 hits the guide surface 26. In this position S1, the locking bolt 26 is in first contact with the guide surface 26. After a further movement of the roller door 3 in the direction of the arrow P, the cross-member 1 is deflected by the interaction of the locking bolt 25 and the guide surface 26. The locking bolt reaches the guide slot 28 so that the lock holder 7 comes into engagement with the motor vehicle lock 16 and in particular the insertion region 30 of the motor vehicle lock 16. After further moving the roller door in the direction of arrow P, the closing position S3 is reached. In this closing position S3, the lock holder 7 is locked with the motor vehicle lock and in particular the locking mechanism in the motor vehicle lock 16, and the roller door or the access 29 is completely closed.

In FIG. 5, the movement sequence as has been described in FIG. 4 is portrayed in a top view of the motor vehicle lock and the cross-member 1. The closing positions S1, S2, S3 correspond to the closing positions according to FIG. 4. The receiving bearing 2 as well as the cross-member 1 are moved in the direction of the arrow P so that the guide bolt 25 comes into engagement with the guide plate 18, and the lock holder 7 is pivoted. The overall cross-member 1 is pivoted counterclockwise in the direction of the arrow P1, wherein the stop 11 is released from the recess 12. Due to the pivoting movement of the cross-member 1, the lock holder 7 enters aligned into the insertion region 30 of the motor vehicle lock 16, such that a secure closing or locking of the locking mechanism and therefore a holding of the roller door can be ensured. The lock holder 7 is consequently guided pivotably by means of the cross-member 1 and aligned at an optimal angle a to the motor vehicle lock 16. Due to the inventive design of the motor vehicle door latch, the access region 29 of the roller door 3 can be kept free of components of the motor vehicle door latch. For additional security of the access region, the guide plate can, as shown, be provided to be form-fit, e.g., by means of a bevel 31, so that safe and unhindered access to the motor vehicle 4 is possible.

### LIST OF REFERENCE SIGNS

1 Cross-member
2 Receiving bearing
3 Roller door
4 Motor vehicle, body
5 Guide rail
6 Segment
7 Lock holder
8, 22 Bead
9 Pivot axis
10 Leg spring
11 Stop
12 Recess
13, 14, 24, 31 Bevel
15 Bore
16 Motor vehicle lock
17 End region
18 Guide plate
19 Reinforcing plate
20 Mounting region
21 Bearing point
23 Leg
25 Guide bolt
26 Guide surface
27 Extension
28 Guide slot
29 Access
30 Insertion region
Z Direction of the coordinate system
α Angle
S1, S2, S3 Closing position
P, P1 Arrow

1. A motor vehicle door latch for a motor vehicle comprising:
a door lock with a locking mechanism, the door lock having an engagement region and
a lock holder pivotably arranged on the motor vehicle,
wherein the lock holder is adjustable with respect to the door lock, and
wherein the lock holder configured to be pivotable into the engagement region of the door lock.

2. The motor vehicle door latch according to claim 1, wherein the lock holder is held in the motor vehicle by a spring preload.

3. The motor vehicle door latch according to claim 1, wherein the lock holder is configured to be positioned out of engagement region of the door lock by a spring.

4. The motor vehicle door latch according to claim 1, further comprising a door element wherein the door element has an overlapping region, and wherein the lock holder is positioned within the overlapping region of the door element.

5. The motor vehicle door latch according to claim 1, further comprising a cross-member, wherein the lock holder is attached to the cross-member.

6. The motor vehicle door latch according to claim 5,
wherein the cross-member includes an end region and a guide element at the end region, and
wherein the cross-member is configured to be by the guide element.

7. The motor vehicle door latch according to claim 6, further comprising a guide plate, wherein the guide element is configured to engage with the guide plate.

8. The motor vehicle door latch according to claim 7, wherein the guide plate is configured to be adaptable to a body of the motor vehicle.

9. The motor vehicle door latch according to claim 5, wherein the cross-member has a stop.

10. The motor vehicle door latch according to claim 5, further comprising a receiving bearing, wherein the cross-member is pivotally accommodated in a receiving bearing.

11. The motor vehicle door latch according to claim 10, further comprising reinforcing plate, wherein the reinforcing plate is arranged on the receiving bearing.

12. The motor vehicle door latch according to claim 6, wherein the guide element is a part of the lock holder.

13. The motor vehicle door latch according to claim 1, wherein the door lock is arranged in the motor vehicle in a direction deviating from a direction of movement of the door element.

14. The motor vehicle door latch according to claim 1, wherein a direction of the engagement region of the lock holder into the door lock is greater than 20°.

15. The motor vehicle door latch according to claim 7, wherein the door lock is arranged on the guide plate.

16. The motor vehicle door latch according to claim 3, wherein the spring is a leg spring.

17. The motor vehicle door latch according to claim 5, wherein the cross-member is pivotably mounted about a pivot axis.

18. The motor vehicle door latch according to claim 6, wherein the guide element is a guide bolt.

19. The motor vehicle door latch according to claim 14, wherein the direction of the engagement region of the lock holder into the door lock is greater than 30°.

20. The motor vehicle door latch according to claim 19, wherein the direction of the engagement region of the lock holder into the door lock is greater than 40°.
